(19) United States
(12) Patent Application Publication
(10) Pub. No.: US 2026/0084423 A1
(43) Pub. Date: Mar. 26, 2026

(54) HEAD CHIP, LIQUID JET HEAD, AND LIQUID JET RECORDING APPARATUS

(71) Applicant: SII Printek Inc., Chiba-shi (JP)

(72) Inventors: Tooru MINE, Chiba-shi (JP); Tomoaki Hoshi, Chiba-shi (JP)

(21) Appl. No.: 19/331,811

(22) Filed: Sep. 17, 2025

(30) Foreign Application Priority Data
Sep. 24, 2024 (JP) 2024-164762

(51) Int. Cl. B41J 2/14

(52) U.S. Cl. CPC B41J 2/14209; B41J 2/14233; B41J 2002/14491

(57) ABSTRACT

A failure in conduction due to broken line of an electrode formed in a non-jet channel is suppressed to enhance the reliability of driving. A head chip includes an actuator plate in which ejection channels filled with ink and non-ejection channels not filled with the ink each extend in a Y-axis direction, and are alternately formed across a drive wall in an X-axis direction, a common electrode formed on an inner surface of the ejection channel, and an individual electrode formed on an inner surface of the non-ejection channel, wherein a first principal surface facing to a −Z side in the actuator plate includes an individual electrode feeding part disposed at a −Y side of a first opening and configured to supply drive power to a pair of individual electrodes located across the ejection channel in the X-axis direction, and a bypass interconnection disposed at a +Y side of the first opening, and configured to couple the pair of individual electrodes to each other.

### RELATED APPLICATIONS

This application claims priority to Japanese Patent application No. JP 2024-164762, filed on Sep. 24, 2024, the entire content of which is incorporated herein by reference.

### BACKGROUND OF THE INVENTION

### 1. Field of the Invention

The present disclosure relates to a head chip, a liquid jet head, and a liquid jet recording apparatus.

### 2. Description of the Related Art

JP2020-75444A discloses a liquid jet head which is provided with an actuator plate for applying pressure to a liquid and a wiring board, and jets the liquid. The actuator plate is provided with a first surface, a second surface facing to an opposite side to the first surface, and ejection channels and non-ejection channels which have an opening on at least one of the first surface and the second surface, and are alternately arranged so as to be separated from each other.

A common electrode is disposed on a sidewall of the ejection channel. An individual electrode electrically separated from the common electrode is disposed on a sidewall of the non-ejection channel.

Further, a common electrode pad which electrically couples the common electrode and the wiring board is disposed on the first surface, and a bypass interconnection which electrically couples the individual electrodes in the non-ejection channels adjacent to each other is disposed on the second surface.

In the related art described above, when a broken line occurs in either one of the individual electrodes of the non-ejection channels adjacent to each other, conduction can be ensured when the broken line of the individual electrode occurs at a front side (a tail portion side) of that bypass interconnection, but the conduction cannot be ensured when the broken line of the individual electrode occurs at a back side (an opposite side to the tail portion side) of the bypass interconnection.

The present disclosure has an object that a failure in conduction due to the broken line of the electrode formed in the non-jet channel to thereby enhance the reliability of driving.

### SUMMARY OF THE INVENTION

In order to solve the problems described above, the present disclosure adopts the following aspects.

(1) A head chip according to an aspect of the present disclosure includes an actuator plate in which jet channels to be filled with a liquid and non-jet channels not to be filled with the liquid each extend in a first direction, and are alternately formed in a second direction crossing the first direction across drive walls, a first electrode formed on an inner surface of the jet channel, and a second electrode formed on an inner surface of the non-jet channel, wherein a first principal surface facing to one side in a third direction crossing the first direction and the second direction in the actuator plate includes a second electrode feeding part disposed at one side in the first direction of a first opening which opens on the first principal surface in the jet channel and configured to supply drive power to a pair of second electrodes which are located across the jet channel in the second direction and each of which is identical to the second electrode, and a bypass interconnection disposed at another side in the first direction of the first opening, and configured to couple the pair of second electrodes to each other.

According to the present aspect, even when broken line occurs in either one of the pair of second electrodes, the conduction is achieved by a path from the second electrode feeding part to the one second electrode through the other second electrode in which the broken line does not occur and via the bypass interconnection, and therefore, the reliability of driving can be enhanced. Further, the bypass interconnection is formed on the first principal surface of the actuator plate, and can therefore be formed at the same time as the formation of other conductive patterns, and thus, it is possible to suppress a rise in cost and an increase in lead time due to an increase in manufacturing steps.

(2) In the head chip according to aspect (1) described above, a first electrode feeding part which is formed along an opening edge of the first opening to have an annular shape, and is coupled to the first electrode may be provided to the first principal surface, and when defining a shortest distance between the first electrode feeding part and the bypass interconnection as D1, and a shortest distance between the first electrode feeding part and the second electrode as D2, a relationship of D1>D2 may be provided.

According to the present aspect, by making the shortest distance between the first electrode feeding part and the bypass interconnection longer than the shortest distance between the first electrode feeding part and the second electrode, it is possible to suppress the occurrence of the short circuit due to the liquid bridge between the first electrode feeding part and the bypass interconnection to thereby enhance the reliability of driving.

(3) In the head chip according to one of aspects (1) and (2) described above, a first electrode feeding part which is formed along an opening edge of the first opening to have an annular shape, and is coupled to the first electrode may be provided to the first principal surface, and when defining a shortest distance between the first electrode feeding part and the bypass interconnection as D1, and a shortest distance between the first electrode and the second electrode as D3, a relationship of D1≥D3 may be provided.

According to the present aspect, by making the shortest distance between the first electrode feeding part and the bypass interconnection equal to or longer than the shortest distance between the first electrode and the second electrode (i.e., the thickness of the drive wall), a sufficient distance is ensured between the first electrode feeding part and the bypass interconnection, and thus, the occurrence of the short circuit due to the liquid bridge between the first electrode feeding part and the bypass interconnection can more reliably be suppressed.

(4) In the head chip according to any of aspects (1) to (3) described above, the first principal surface may include a first electrode feeding part which is formed along an opening edge of the first opening to have an annular shape, and is coupled to the first electrode, and a decoupling groove extending in the second direction and configured to decouple the first electrode feeding part and the second electrode feeding part from each other, and when defining a smallest width of the bypass interconnection as W1, and a smallest width of the second electrode in a region where the decoupling groove is disposed as W2, a relationship of W1≥W2 may be provided.

According to the present aspect, since the smallest width of the bypass interconnection is equal to or larger than the smallest width of the second electrode in the region in which the decoupling groove is disposed, it is possible to prevent the wiring resistance in the bypass interconnection from becoming higher than the wiring resistance in that region. Thus, it is possible to prevent the broken line of the bypass interconnection due to the electrical load at the time of driving (ejection).

(5) In the head chip according to any of aspects (1) to (4) described above, the jet channel may include an uprise part gradually decreasing in dimension in the first direction toward one side in the third direction when viewed from the second direction, and the bypass interconnection may be formed so as to cross the uprise part when viewed from the third direction.

According to the present aspect, by disposing the bypass interconnection so as to cross the formation area of the uprise part, it is possible to suppress the growth in size of the actuator plate in the first direction caused by adding the bypass interconnection.

(6) In the head chip according to any of aspects (1) to (5) described above, the first principal surface may include a first electrode feeding part which is formed along an opening edge of the first opening to have an annular shape, and is coupled to the first electrode, and a bypass groove extending in the second direction at one side in the first direction of the first opening, and the bypass interconnection may be formed in the bypass groove.

According to the present aspect, by providing the bypass groove, the bypass interconnection is not formed coplanar with the first electrode feeding part, and thus, the occurrence of the short circuit due to the liquid bridge between the first electrode feeding part and the bypass interconnection can reliably be suppressed.

(7) In the head chip according to any of aspects (1) to (6) described above, the first principal surface may include a first electrode feeding part which is formed along an opening edge of the first opening to have an annular shape, and is coupled to the first electrode, and a decoupling groove extending in the second direction and configured to decouple the first electrode feeding part and the second electrode feeding part from each other, and a second principal surface facing to another side in the third direction in the actuator plate may include a second bypass interconnection which is disposed between a second opening that opens on the second principal surface in the jet channel and the decoupling groove in the first direction, and extends in the second direction to couple a pair of second electrodes each identical to the second electrode to each other.

According to the present aspect, the risk of the broken line in a region of the decoupling groove where the width of the second electrode decreases can be avoided with the second bypass interconnection.

(8) A liquid jet head according to the present disclosure includes the head chip according to any of aspects (1) to (7) described above.

According to the present aspect, the reliability of driving can be enhanced.

(9) A liquid jet recording apparatus according to the present disclosure includes the liquid jet head according to aspect (8) described above.

According to the present aspect, the reliability of driving can be enhanced.

According to an aspect of the present disclosure, it is possible to suppress a failure in conduction due to the broken line in the electrode formed in the non-jet channel to thereby enhance the reliability of driving.

### BRIEF DESCRIPTION OF THE DRAWINGS

FIG. 1 is a schematic configuration diagram of a printer according to a first embodiment.

FIG. 2 is a schematic configuration diagram of an inkjet head and an ink circulation mechanism related to the first embodiment.

FIG. 3 is an exploded perspective view of a head chip according to the first embodiment.

FIG. 4 is a cross-sectional view corresponding to the line IV-IV shown in FIG. 3.

FIGS. 5A, 5B and 5C are each a configuration diagram of an essential part of an actuator plate related to the first embodiment.

FIG. 6 is a flowchart showing a method of manufacturing the head chip according to the first embodiment.

FIGS. 7A, 7B and 7C are each a configuration diagram of an essential part of an actuator plate related to a second embodiment.

FIGS. 8A, 8B and 8C are each a configuration diagram of an essential part of an actuator plate related to a third embodiment.

FIGS. 9A, 9B and 9C are each a configuration diagram of an essential part of an actuator plate related to a fourth embodiment.

### BRIEF DESCRIPTION OF THE DRAWINGS

Some embodiments according to the present disclosure will hereinafter be described with reference to the drawings. In the embodiments and modified examples hereinafter described, constituents corresponding to each other will be denoted by the same reference symbols to omit the descriptions thereof in some cases. In the following descriptions, expressions representing relative or absolute arrangements such as “parallel,” “perpendicular,” “central,” and “coaxial” not only represent strictly such arrangements, but also represent the state of being relatively displaced with a tolerance, or an angle or a distance to the extent that the same function can be obtained. In the following embodiment, the description will be presented citing an inkjet printer (hereinafter referred to simply as a printer) for performing recording on a recording target medium using ink (a liquid) as an example. The scale size of each member is arbitrarily modified so as to provide a recognizable size to the member in the drawings used in the following description.

### First Embodiment

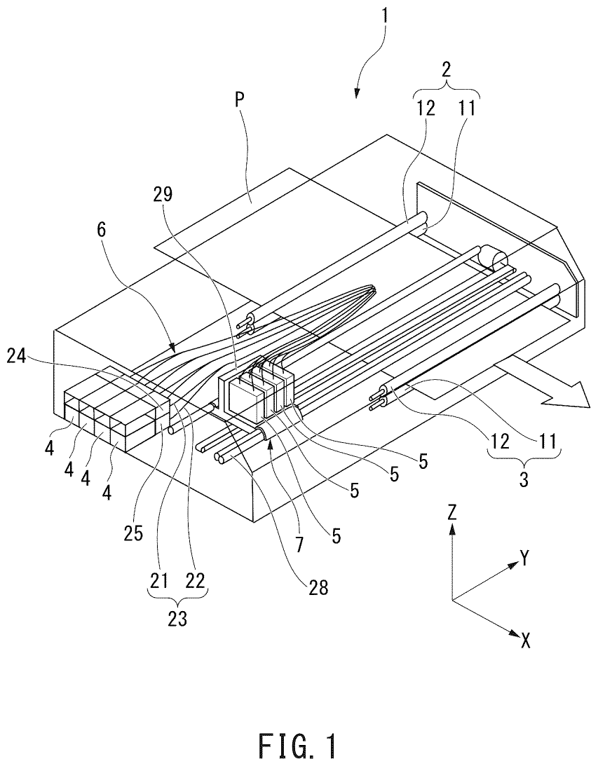

FIG. 1 is a schematic configuration diagram of a printer 1 according to a first embodiment.

As shown in FIG. 1, the printer 1 (a liquid jet recording apparatus) is provided with conveyance mechanisms 2, 3, ink tanks 4, inkjet heads 5 (liquid jet heads), ink circulation mechanisms 6, and a scanning mechanism 7.

In the following explanation, the description is presented using an orthogonal coordinate system of X, Y, and Z as needed. In this case, the X-axis direction coincides with a conveyance direction (a sub-scanning direction) of a recording target medium P (e.g., paper). The Y-axis direction coincides with a scanning direction (a main scanning direction) of the scanning mechanism 7. The Z-axis direction represents a height direction (a gravitational direction) perpendicular to the X-axis direction and the Y-axis direction. In the following explanation, the description will be presented defining an arrow side as a positive (+) side, and an opposite side to the arrow as a negative (−) side in the drawings in each of the X-axis direction, the Y-axis direction, and the Z-axis direction. In FIG. 1, the +Z side corresponds to an upper side in the gravitational direction, and the −Z side corresponds to a lower side in the gravitational direction.

The conveyance mechanisms 2, 3 convey the recording target medium P toward the +X side. The conveyance mechanisms 2, 3 each include a pair of rollers 11, 12 extending in, for example, the Y-axis direction.

The ink tanks 4 respectively contain ink of four colors such as yellow, magenta, cyan, and black. The inkjet heads 5 are configured so as to be able to respectively eject the four colors of ink, that is, yellow ink, magenta ink, cyan ink, and black ink in accordance with the ink tanks 4 coupled to the inkjet heads 5. It should be noted that water-based ink (electrically-conductive ink) using water as a solvent can be exemplified as the ink contained in the ink tanks 4.

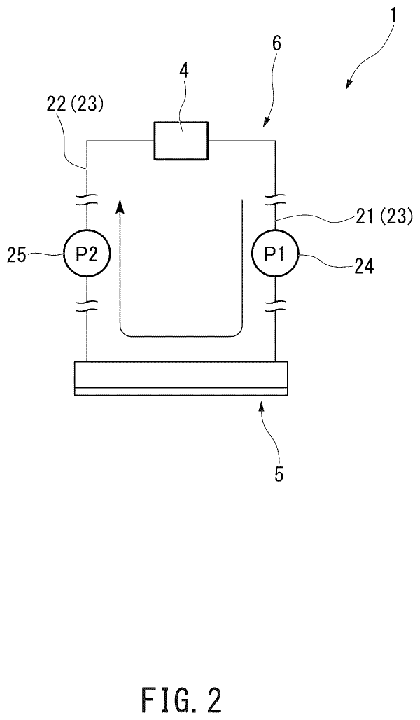

FIG. 2 is a schematic configuration diagram of the inkjet head 5 and the ink circulation mechanism 6 related to the first embodiment.

As shown in FIG. 2, the ink circulation mechanism 6 circulates the ink between the ink tank 4 and the inkjet head 5. Specifically, the ink circulation mechanism 6 is provided with a circulation flow path 23 having an ink supply tube 21 and an ink discharge tube 22, a pressure pump 24 coupled to the ink supply tube 21, and a suction pump 25 coupled to the ink discharge tube 22.

The pressure pump 24 pressurizes an inside of the ink supply tube 21 to deliver the ink to the inkjet head 5 through the ink supply tube 21. Thus, the ink supply tube 21 is provided with positive pressure with respect to the inkjet head 5.

The suction pump 25 depressurizes the inside of the ink discharge tube 22 to suction the ink from the inkjet head 5 through the ink discharge tube 22. Thus, the ink discharge tube 22 is provided with negative pressure with respect to the inkjet head 5. The ink circulates between the inkjet head 5 and the ink tank 4 through the circulation flow path 23 due to drive of the pressure pump 24 and the suction pump 25.

As shown in FIG. 1, the scanning mechanism 7 reciprocates the inkjet heads 5 in the Y-axis direction. The scanning mechanism 7 is provided with a guide rail 28 extending in the Y-axis direction, and a carriage 29 movably supported by the guide rail 28.

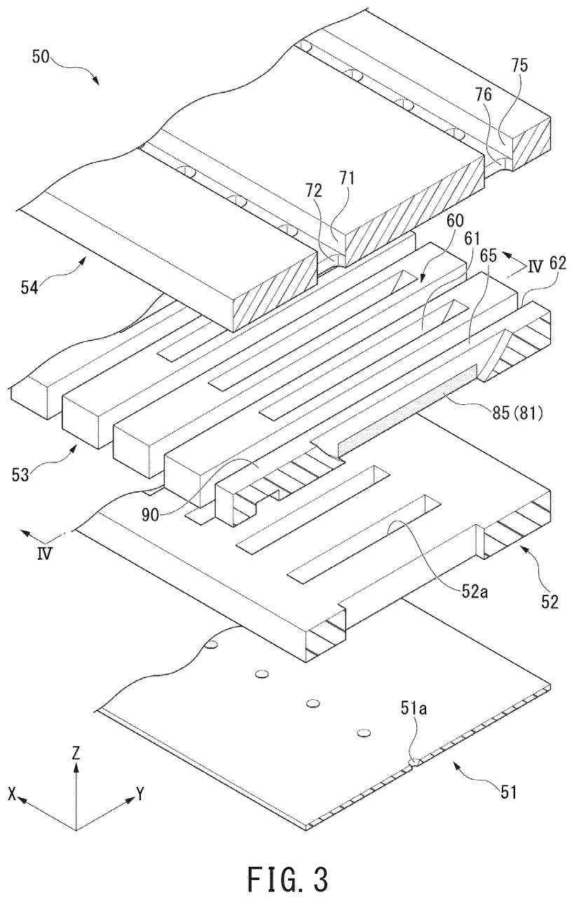

The inkjet heads 5 are mounted on the carriage 29. In the illustrated example, the plurality of inkjet heads 5 is mounted on the single carriage 29 so as to be arranged side by side in the Y-axis direction. The inkjet heads 5 are each provided with a head chip 50 (see FIG. 3), an ink supply unit (not shown) for coupling the ink circulation mechanism 6 and the head chip 50, and a control unit (not shown) for applying drive voltages to the head chip 50.

FIG. 3 is an exploded perspective view of the head chip 50 according to the first embodiment.

The head chip 50 shown in FIG. 3 is a so-called circulating side-shoot type head chip 50 which ejects the ink from a central portion in the extending direction (the Y-axis direction) in the ejection channel 61. The head chip 50 is provided with a nozzle plate 51, an intermediate plate 52 (a bonding member), an actuator plate 53, and a cover plate 54. The head chip 50 is provided with a configuration in which the nozzle plate 51, the intermediate plate 52, the actuator plate 53, and the cover plate 54 are stacked on one another in this order in the Z-axis direction (a third direction).

The actuator plate 53 is formed of, for example, PZT (lead zirconate titanate) as a piezoelectric material including an oxide. The actuator plate 53 is a so-called monopole substrate in which the polarization direction is set to a single direction in, for example, the Z-axis direction. It should be noted that the actuator plate 53 can be a so-called chevron substrate in which the polarization direction is different between the positive side and the negative side in the Z-axis direction.

The actuator plate 53 is provided with a channel array 60. The channel array 60 includes ejection channels 61 (jet channels) filled with the ink, and non-ejection channels 62 (non-jet channels) not filled with the ink. The ejection channels 61 and the non-ejection channels 62 are alternately arranged at intervals in the X-axis direction (a second direction) in the actuator plate 53. The configuration in which the channel extension direction (a first direction) coincides with the Y-axis direction will be described in the first embodiment, but the channel extension direction can cross the Y-axis direction.

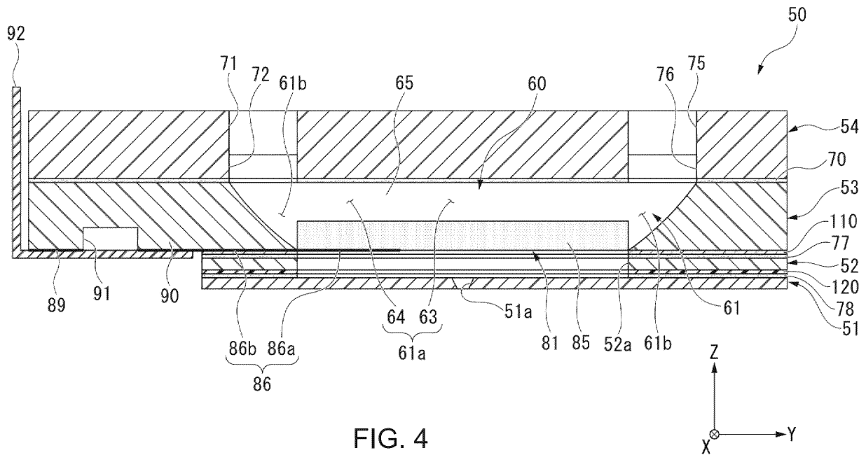

FIG. 4 is a cross-sectional view corresponding to the line IV-IV shown in FIG. 3.

As shown in FIG. 4, the ejection channel 61 is formed to have a circular arc shape convex downward (at one side in the third direction) when viewed from the X-axis direction. In other words, a dimension in the Y-axis direction in the ejection channel 61 gradually decreases in a direction from the upper side toward the lower side. Specifically, the ejection channel 61 is provided with a penetration part 61a located in a central portion in the Y-axis direction, and uprise parts 61b connected to both sides in the Y-axis direction to the penetration part 61a.

The penetration part 61a penetrates the actuator plate 53 in the Z-axis direction. An intermediate area in the Y-axis direction in the penetration part 61a forms a uniform part 63 which is uniform in dimension in the X-axis direction throughout the whole length in the Z-axis direction. In the penetration part 61a, portions located at both sides in the Y-axis direction with respect to the uniform part 63 each form a changing part 64. The changing part 64 gradually decreases in dimension in the X-axis direction (a distance between inner side surfaces of the ejection channel 61) in a direction from the upper side toward the lower side. It should be noted that the penetration part 61a may have a configuration in which the changing part 64 is not provided.

The uprise parts 61b each open on the upper surface of the actuator plate 53, and at the same time, the dimension in the Z-axis direction of the uprise part 61b gradually decreases as getting away in the Y-axis direction from the penetration part 61a. In other words, an upper end opening of the ejection channel 61 is formed of the penetration part 61a and the uprise part 61b. In contrast, a lower end opening of the ejection channel 61 is formed of the penetration part 61a. It should be noted that a bottom surface of the uprise part 61b is formed to have a circular arc shape uniform in curvature radius.

As shown in FIG. 3, the non-ejection channel 62 linearly extends in the Y-axis direction in the state of penetrating the actuator plate 53 in the Z-axis direction. Portions of the actuator plate 53, the portions each being located between the ejection channel 61 and the non-ejection channel 62 adjacent to each other, each form a drive wall 65. Therefore, both sides in the X-axis direction of each of the channels 61, 62 are surrounded by the pair of drive walls 65.

Although the description is presented in the present embodiment citing the head chip 50 having the single channel array 60 as an example, it is possible to dispose a plurality of channel arrays 60 in the Y-axis direction. On this occasion, it is preferable for the ejection channels 61 constituting the channel arrays 60 adjacent to each other to be arranged so as to be shifted for 1/n pitch with respect to an arrangement pitch of the ejection channels 61 in one of the channel arrays 60 assuming the number of the channel arrays 60 as n.

The head chip 50 is provided with a processed film 110 and a protective film 120. The processed film 110 is for ensuring bonding force between the actuator plate 53 and an adhesive, and a surface treatment such as a silane coupling treatment is performed on the processed film 110. It should be noted that the treatment is not limited to the silane coupling treatment providing the material of the processed film 110 is a material which is higher in bonding force with the actuator plate 53 compared to the bonding force between the actuator plate 53 and the adhesive.

The protective film 120 protects the electrodes provided to the actuator plate 53 from the ink. The protective film 120 is formed of an organic insulating material such as a para-xylylene resin material (e.g., parylene (a registered trademark)). It should be noted that the protective film 120 can be formed of tantalum oxide (Ta₂O₅), silicon nitride (SiN), silicon carbide (SiC), silicon oxide (SiO₂), diamond-like carbon, or the like, or can include at least any one of these materials.

As shown in FIG. 3 and FIG. 4, the cover plate 54 is bonded to an upper surface of the actuator plate 53 via an adhesive 70 so as to cover the upper end openings of the channels 61, 62. As the adhesive 70, there is used, for example, an epoxy adhesive.

In the cover plate 54, at a position overlapping the −Y-side end portion of the channel array 60 in the plan view, there is formed an entrance common ink chamber 71. The entrance common ink chamber 71 extends in the X-axis direction with a length sufficient for straddling, for example, the channel array 60, and at the same time, opens on the upper surface of the cover plate 54.

In the entrance common ink chamber 71, at the positions overlapping the respective ejection channels 61 in the plan view, there are formed entrance slits 72. The entrance slits 72 each communicate the −Y-side end portion of corresponding one of the ejection channels 61 and the entrance common ink chamber 71 with each other.

In the cover plate 54, at a position overlapping the +Y-side end portion of the channel array 60 in the plan view, there is formed an exit common ink chamber 75. The exit common ink chamber 75 extends in the X-axis direction with a length sufficient for straddling, for example, the channel array 60, and at the same time, opens on the upper surface of the cover plate 54.

In the exit common ink chamber 75, at the positions overlapping the respective non-ejection channels 62 in the plan view, there are formed exit slits 76. The exit slits 76 each communicate the +Y-side end portion of corresponding one of the ejection channels 61 and the exit common ink chamber 75 with each other. Therefore, the entrance slits 72 and the exit slits 76 are communicated with the respective ejection channels 61 on the one hand, but are not communicated with the non-ejection channels 62 on the other hand.

The intermediate plate 52 is bonded to the lower surface of the actuator plate 53 via an adhesive 77. The intermediate plate 52 is formed of a material such as polyimide to have a thickness of about several tens of micrometers (e.g., 50 μm). It should be noted that the intermediate plate 52 may be formed of a material (e.g., a piezoelectric material such as PZT or a nonconductive material such as alumina) other than polyimide.

In the intermediate plate 52, at a position overlapping the ejection channel 61 (the penetration part 61a) in the plan view, there is formed a communication hole 52a. The communication hole 52a penetrates the intermediate plate 52 in the Z-axis direction. The communication hole 52a is communicated with the ejection channel 61 through the lower end opening of the ejection channel 61. It should be noted that the intermediate plate 52 is not an essential constituent.

The nozzle plate 51 is bonded to a lower surface of the intermediate plate 52 via an adhesive 78. The nozzle plate 51 is formed of a metal material (SUS, Ni—Pd, and so on) so as to have a thickness of about 50 μm. It should be noted that it is possible for the nozzle plate 51 to have a single layer structure or a laminate structure with a resin material (polyimide or the like), glass, silicone, or the like besides the metal material.

The nozzle plate 51 is provided with a plurality of nozzle holes 51a penetrating the nozzle plate 51 in the Z-axis direction. The nozzle holes 51a are each formed to have, for example, a taper shape having the inner diameter gradually decreasing along a direction from the upper side toward the lower side. The nozzle holes 51a are arranged at intervals in the X-axis direction. The nozzle holes 51a are respectively communicated with the corresponding ejection channels 61 through the communication holes 52a. Therefore, the non-ejection channels 62 are not communicated with the nozzle holes 51a, but are covered with the nozzle plate 51 from below.

The actuator plate 53 is provided with common interconnections 81 and individual interconnections (not shown in FIG. 4). The common interconnections 81 include common electrodes 85 (first electrodes) and a common electrode feeding part 86 (a first electrode feeding part). The common electrodes 85 are formed as a pair of electrodes on the inner side surfaces opposed to each other in the X-axis direction out of the inner surfaces of the ejection channel 61. The common electrodes 85 are each formed on the inner side surface of the ejection channel 61 (the penetration part 61a) in about a lower half of the area.

The common electrode feeding part 86 surrounds a lower end opening edge of the ejection channel 61 in the lower surface of the actuator plate 53, and couples the pair of common electrodes 85 to each other. The common electrode feeding part 86 includes extraction parts 86a and a coupling part 86b. The extraction parts 86a are respectively formed at both sides in the X-axis direction on the lower end opening edge of the ejection channel 61. The coupling part 86b is formed in a portion (hereinafter referred to as a tail part 90) located at the −Y side of the ejection channel 61 in the lower surface of the actuator plate 53.

The coupling part 86b is disposed on the lower surface of the tail part 90 so as to correspond to each of the ejection channels 61. The coupling parts 86b each extend linearly in the Y-axis direction with respect to corresponding one of the ejection channels 61. The +Y-side end portions in the coupling part 86b are respectively coupled to the pair of extraction parts 86a. In the illustrated example, the +Y-side end portions of the coupling part 86b reach the −Y-side end edge in the lower end opening edge of the ejection channel 61.

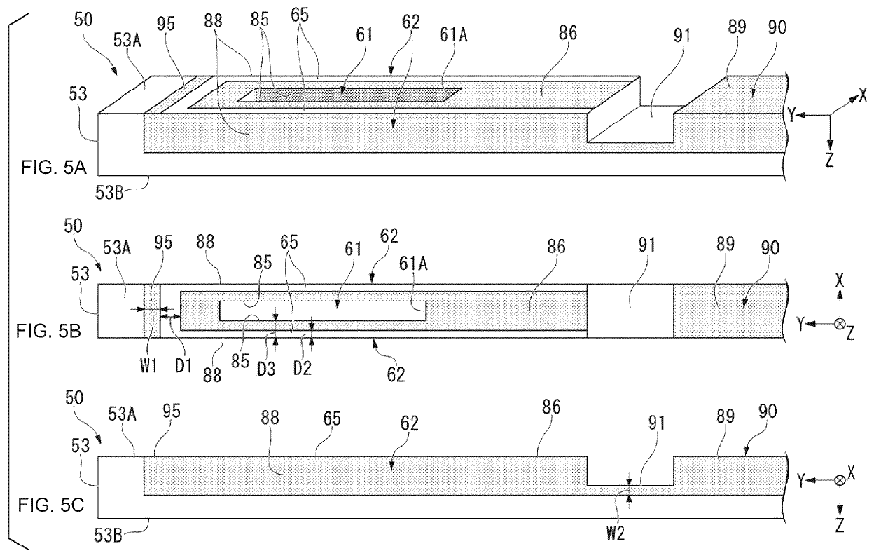

On the lower surface of the tail part 90, there is formed an individual electrode feeding part 89 (a second electrode feeding part). The individual electrode feeding part 89 is provided to a portion located at the −Y side of the common electrode feeding part 86 on the lower surface of the tail part 90. The individual electrode feeding part 89 couples individual electrodes 88 (see FIGS. 5A to 5C described later) opposed to each other in the X-axis direction across the ejection channel 61 at the lower end opening edges of the non-ejection channels 62 which are opposed to each other in the X-axis direction across the ejection channel 61.

In the tail part 90, in a portion located between the common electrode feeding part 86 and the individual electrode feeding part 89, there is formed a partition groove 91 (a decoupling groove). The partition groove 91 extends in the X-axis direction in the tail part 90. The partition groove 91 decouples the common electrode feeding part 86 and the individual electrode feeding part 89 from each other. To the lower surface of the tail part 90, there is pressure-bonded a flexible printed board 92. The flexible printed board 92 is coupled to the common electrode feeding parts 86 and the individual electrode feeding parts 89 on the lower surface of the tail part 90. The flexible printed board 92 is extracted upward passing through the outside of the actuator plate 53.

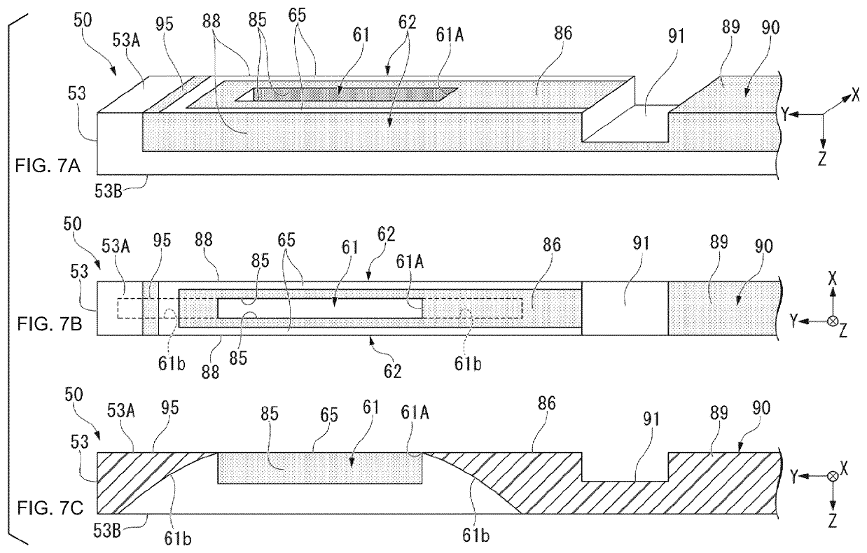

FIGS. 5A to 5C are each a configuration diagram of an essential part of the actuator plate 53 related to the first embodiment. It should be noted that FIG. 5A is a perspective view of a part of the actuator plate 53 viewed from the −Z side. FIG. 5B is a plan view of a part of the actuator plate 53 viewed from the −Z side. FIG. 5C is a side view of a part of the actuator plate 53 viewed from the −X side. The same applies to the illustration of FIGS. 7A to 7C, FIGS. 8A to 8C, and FIGS. 9A to 9C described later.

It should be noted that in the following description, a surface facing to the −Z side (one side in the third direction) of the actuator plate 53 is referred to as a first principal surface 53A, and a surface facing to the +Z side (the other side in the third direction) of the actuator plate 53 is referred to as a second principal surface 53B.

As shown in FIGS. 5A to 5C, the individual interconnection is provided with individual electrodes (second electrodes) 88, and the individual electrode feeding part 89. The individual electrodes 88 are each formed on one of the inner side surfaces opposed to each other in the X-axis direction out of the inner surfaces of each of the non-ejection channels 62. In the illustrated example, the individual electrodes 88 are each formed on the inner side surface of the non-ejection channel 62 in about a half of the area. It should be noted that providing the conduction with the individual electrode feeding part 89 is ensured, it is sufficient for the individual electrodes 88 to be formed in at least an area overlapping the common electrodes 85 when viewed from the X-axis direction. The individual electrode feeding part 89 is formed at the −Y side of the tail part 90, and feeds drive power to the pair of individual electrodes 88 located across the ejection channel 61 in the X-axis direction.

A first opening 61A (a lower end opening) of the ejection channel 61 is formed on the first principal surface 53A of the actuator plate 53. The first opening 61A is illustrated in FIGS. 5A to 5C in a rectangular shape elongated in the Y-axis direction in the plan view, but in reality, an opening end of the first opening 61A has a circular arc shape or a tapered shape, and this shape is not a limitation. The same applies to FIGS. 7A to 7C, FIGS. 8A to 8C, and FIGS. 9A to 9C described later. On an opening edge of the first opening 61A on the first principal surface 53A, there is formed the common electrode feeding part 86. The common electrode feeding part 86 is formed in a rectangular annular shape extending in the Y-axis direction in the plan view. The common electrode feeding part 86 is coupled to the pair of common electrodes 85 formed on inner surfaces of the ejection channel 61.

On the first principal surface 53A of the actuator plate 53, there are formed the individual electrode feeding part 89 and a bypass interconnection 95 across the first opening 61A and the common electrode feeding part 86 in the Y-axis direction (the first direction). The individual electrode feeding part 89 is disposed at the −Y side (one side in the first direction) with respect to the first opening 61A and the common electrode feeding part 86, and is coupled to end portions at the −Y side of the pair of individual electrodes 88 located across the ejection channel 61 in the X-axis direction.

The bypass interconnection 95 is disposed at the +Y side (the other side in the first direction) with respect to the first opening 61A and the common electrode feeding part 86, and couples the pair of individual electrodes 88 located across the ejection channel 61 in the X-axis direction to each other. The bypass interconnection 95 is an electrical conductor with a constant width extending in the X-axis direction, and couples end portions at the +Y side of the pair of individual electrodes 88 to each other. The bypass interconnection 95 is arranged to be able to supply the drive power to one of the pair of individual electrodes 88 via the other of the pair of individual electrodes 88 even when broken line occurs in the one of the pair of individual electrodes 88 by coupling the pair of individual electrodes 88 to each other at an opposite side to the individual electrode feeding part 89 with respect to the first opening 61A and the common electrode feeding part 86. As described later, the bypass interconnections 95 are formed in the same step as a step in which the common electrodes 85, the common electrode feeding parts 86, the individual electrodes 88, and the individual electrode feeding parts 89 are formed.

The bypass interconnection 95 is formed with a gap with respect to the common electrode feeding part 86. When defining the shortest distance between the common electrode feeding part 86 and the bypass interconnection 95 as D1, and the shortest distance between the common electrode feeding part 86 and the individual electrode 88 as D2, a relationship of D1>D2 is provided. In other words, the bypass interconnection 95 is formed at a longer distance from the common electrode feeding part 86 than a distance at which the individual electrode 88 is located from the common electrode feeding part 86. It should be noted that the shortest distance D2 between the common electrode feeding part 86 and the individual electrode 88 is designed to be able to prevent short circuit due to an ink bridge from occurring.

Further, when defining the shortest distance between the common electrode feeding part 86 and the bypass interconnection 95 as D1, and the shortest distance between the common electrode 85 and the individual electrode 88 as D3, a relationship of D1≥D3 is provided. The shortest distance D3 between the common electrode 85 and the individual electrode 88 is a dimension corresponding to the thickness in the X-axis direction of the drive wall 65. In other words, the bypass interconnection 95 is formed at a sufficiently larger distance from the common electrode feeding part 86 than the thickness of the drive wall 65.

On the first principal surface 53A, there is formed the partition groove 91 which decouples the common electrode feeding part 86 and the individual electrode feeding part 89 from each other. The partition groove 91 is formed at a constant depth with respect to the first principal surface 53A. Therefore, a region where the width in the Z-axis direction is partially narrowed exists in the individual electrode 88 (see FIG. 5C). Here, when defining the smallest width of the bypass interconnection 95 as W1, and the smallest width of the individual electrode 88 in the region where the partition groove 91 is disposed as W2, a relationship of W1≥W2 is provided. The smallest width W2 of the individual electrode 88 is designed to have a wiring resistance with which broken line does not occur in the individual electrode 88 due to an electrical load at the time of driving (ejection). In other words, the bypass interconnection 95 is provided with a safety side width with which the wiring resistance is lower than that of the individual electrode 88.

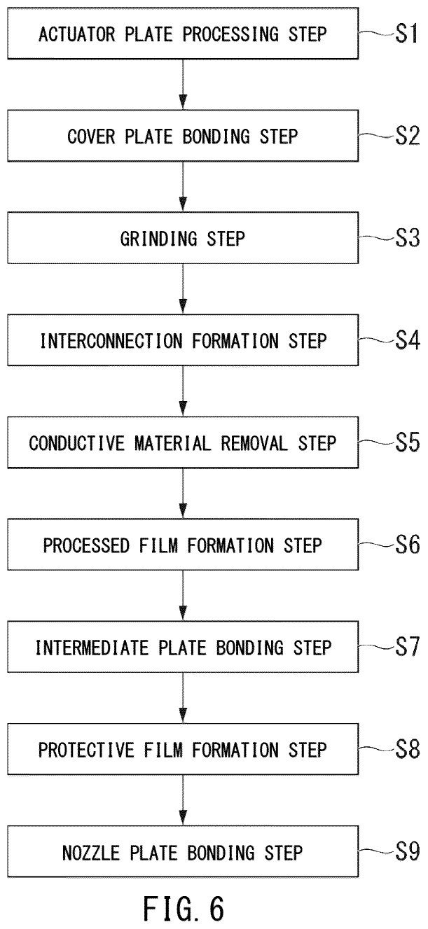

Then, a method of manufacturing the head chip 50 including the actuator plate 53 described above will be described. FIG. 6 is a flowchart showing the method of manufacturing the head chip 50 according to the first embodiment. In the following description, when manufacturing the head chip 50 chip by chip is cited as an example for the sake of convenience.

The method of manufacturing the head chip 50 is provided with an actuator plate processing step S1, a cover plate bonding step S2, a grinding step S3, an interconnection formation step S4, a conductive material removal step S5, a processed film formation step S6, an intermediate plate bonding step S7, a protective film formation step S8, and a nozzle plate bonding step S9.

In the actuator plate processing step S1, a dicer shaped like a disk is made to enter a formation area of the ejection channels 61 and the non-ejection channels 62 in the actuator plate 53 from above the actuator plate 53. In the actuator plate processing step S1, in the formation areas of the non-ejection channels 62, a running amount in the Y-axis direction of the dicer is made larger than that in the formation areas of the ejection channels 61. Thus, the bottom surface of the ejection channel 61 is formed to have a circular arc shape convex downward, and the bottom surface of the non-ejection channel 62 is formed to have a linear shape when viewed from the X-axis direction.

In the cover plate bonding step S2, the cover plate 54 is attached to the upper surface of the actuator plate 53 via the adhesive 70. Thus, the cover plate 54 is stacked on the actuator plate 53.

In the grinding step S3, grinding processing is performed on the lower surface of the actuator plate 53. Specifically, the actuator plate 53 is ground until the ejection channels 61 and the non-ejection channels 62 open on the lower surface of the actuator plate 53. Thus, the first principal surface 53A is provided to the actuator plate 53.

In the interconnection formation step S4, an electrode material is deposited on the first principal surface 53A of the actuator plate 53 to thereby form the drive interconnections. In the interconnection formation step S4, oblique evaporation is performed on the first principal surface 53A of the actuator plate 53 from the +X side and the −X side. Then, an electrode film including the common electrodes 85, the common electrode feeding parts 86, the individual electrodes 88, the individual electrode feeding parts 89, and the bypass interconnections 95 is deposited on the lower surface of the actuator plate 53. Further, while the common electrodes 85 are formed on the inner surfaces of the ejection channels 61, the individual electrodes 88 are formed on the inner surfaces of the non-ejection channels 62.

In the conductive material removal step S5, unwanted portions of the electrode film deposited in the interconnection formation step S4 are removed. Specifically, the first principal surface 53A of the actuator plate 53 is scanned with a laser beam in the X-axis direction and the Y-axis direction. For example, in the actuator plate 53, by removing the conductive material adhering to the periphery of the common electrode feeding part 86, the common electrode feeding part 86 is separated from the individual electrodes 88 and the bypass interconnection 95. Thus, a blank area where laser irradiation scars remain is formed on the periphery of the common electrode feeding part 86. It should be noted that by providing the partition groove 91 to the first principal surface 53A of the actuator plate 53 after the conductive material removal step S5, the common electrode feeding part 86 and the individual electrode feeding part 89 are separated from each other.

In the processed film formation step S6, the laminated body obtained by stacking the actuator plate 53 and the cover plate 54 are stacked on one another is dipped in a processing agent (a silane coupling agent). Thus, the processed film 110 is formed throughout a portion exposed inside each of the channels 61, 62 on the lower surface of the actuator plate 53, the inner surfaces of the channels 61, 62, and the lower surface of the cover plate 54.

In the intermediate plate bonding step S7, the intermediate plate 52 is bonded to the lower surface of the actuator plate 53. Specifically, the adhesive 77 is applied on the lower surface of the actuator plate 53 via the processed film 110, and then the intermediate plate 52 is bonded via the adhesive 77.

In the protective film formation step S8, the protective film 120 is provided to the portions exposed inside the channels 61, 62 in the inner surfaces of the channels 61, 62, the lower surface of the intermediate plate 52, the inner surfaces of the communication holes 52a, and the lower surface of the cover plate 54. It should be noted that when adopting the para-xylylene resin material as the protective film 120, it is possible to form the protective film 120 using, for example, a chemical vapor deposition (CVD) process.

In the nozzle plate bonding step S9, the nozzle plate 51 is attached to the lower surface of the intermediate plate 52 via the adhesive 78 in a state in which the nozzle holes 51a and the ejection channels 61 are aligned with each other.

In this way, the head chip 50 is manufactured.

Then, an operation when recording a character, a figure, or the like on the recording target medium P using the printer 1 illustrated in FIG. 1 will be described below.

It is assumed that in the printer 1, the ink tanks 4 are sufficiently filled with the ink of respective colors different from each other as an initial state. There is created a state in which the inkjet heads 5 are filled with the ink in the ink tanks 4 via the ink circulation mechanisms 6, respectively.

Under such an initial state, when making the printer 1 operate, the recording target medium P is conveyed toward the +X side while being pinched by the rollers 11, 12 of the conveyance mechanisms 2, 3. By the carriage 29 moving in the Y-axis direction at the same time as the conveyance of the recording target medium P, the inkjet heads 5 mounted on the carriage 29 make a reciprocal motion in the Y-axis direction.

While the inkjet heads 5 make the reciprocal motion, the ink is appropriately ejected toward the recording target medium P from each of the inkjet heads 5. Thus, it is possible to perform recording of the character, the image, and the like on the recording target medium P.

Here, the operation of each of the inkjet heads 5 will hereinafter be described in detail.

In such a circulating side-shoot type inkjet head 5 as in the first embodiment, first, by making the pressure pump 24 and the suction pump 25 shown in FIG. 2 operate, the ink is circulated in the circulation flow path 23. In this case, as shown in FIG. 4, the ink flowing through the ink supply tube 21 is supplied to the inside of each of the ejection channels 61 through the entrance common ink chamber 71 and the entrance slits 72. The ink supplied to the inside of each of the ejection channels 61 flows through the ejection channel 61 in the Y-axis direction. Subsequently, the ink is discharged to the exit common ink chamber 75 through the exit slits 76, and is then returned to the ink tank 4 through the ink discharge tube 22. Thus, it is possible to circulate the ink between the inkjet head 5 and the ink tank 4.

When the reciprocation of the inkjet head 5 is started due to the translation of the carriage 29 (see FIG. 1), the drive voltages are applied between the common electrodes 85 and the individual electrodes 88 via the flexible printed board 92. On this occasion, the drive voltage is applied between the electrodes 85, 88 by setting the individual electrode 88 at a drive potential Vdd, and the common electrode 85 at a reference potential GND. Then, an electrical field is generated in a portion sandwiched between opposed regions in each of the drive walls 65, and thus, each of the drive walls 65 makes a flexural deformation to form a V shape centering on a middle portion in the Z-axis direction. In other words, the drive walls 65 deform so that the volume of the ejection channel 61 increases.

After the volume of each of the ejection channels 61 is increased, the voltage applied between the common electrode 85 and the individual electrode 88 is set to zero. Then, the drive walls 65 are restored, and the volume of the ejection channel 61 having once increased is restored to the original volume. Thus, the internal pressure of the ejection channel 61 increases to pressurize the ink. As a result, the ink is ejected as a droplet through the nozzle hole 51a. By the ink ejected from the nozzle hole 51a landing on the recording target medium P, it is possible to record the character, the image, and the like on the recording target medium P.

As described hereinabove, the head chip 50 according to the present embodiment is provided with the actuator plate 53 in which the ejection channels 61 (the jet channels) filled with the ink (the liquid) and the non-ejection channels 62 (the non-jet channels) not filled with the ink each extend in the Y-axis direction (the first direction) and are formed alternately in the X-axis direction (the second direction) crossing the Y-axis direction across the drive wall 65, the common electrodes 85 (the first electrodes) formed on the inner surfaces of the ejection channels 61, and the individual electrodes 88 (the second electrodes) formed on the inner surfaces of the non-ejection channels 62, wherein the individual electrode feeding parts 89 (the second electrode feeding parts) and the bypass interconnections 95 are disposed on the first principal surface 53A facing to the −Z side (one side) in the Z-axis direction crossing the Y-axis direction and the X-axis direction in the actuator plate 53, the individual electrode feeding part 89 is disposed at the −Y side (one side) in the Y-axis direction of the first opening 61A opening on the first principal surface 53A in the ejection channel 61, and supplies the drive power to the pair of individual electrodes 88 located across the ejection channel 61 in the X-axis direction, and the bypass interconnection 95 is disposed at the +Y side (the other side) in the Y-axis direction of the first opening 61A, and couples the pair of individual electrodes 88 to each other.

According to this configuration, even when broken line occurs in either one of the pair of individual electrodes 88, the conduction is achieved by a path from the individual electrode feeding part 89 to the one individual electrode 88 through the other individual electrode 88 in which the broken line does not occur and via the bypass interconnection 95, and therefore, the reliability of driving can be enhanced. Further, the bypass interconnection 95 is formed on the first principal surface 53A of the actuator plate 53, and can therefore be formed at the same time as the formation of other conductive patterns, and thus, it is possible to suppress a rise in cost and an increase in lead time due to an increase in manufacturing steps.

As described above, according to the present embodiment, it is possible to suppress a failure in conduction due to the broken line in the individual electrode 88 formed in the non-ejection channel 62 to thereby enhance the reliability of driving.

Further, in the present embodiment, the common electrode feeding part 86 which is formed along the opening edge of the first opening 61A so as to have an annular shape and is coupled to the common electrode 85 is disposed on the first principal surface 53A, and when defining the shortest distance between the common electrode feeding part 86 and the bypass interconnection 95 as D1, and the shortest distance between the common electrode feeding part 86 and the individual electrode 88 as D2, the relationship of D1>D2 is provided. According to this configuration, by making the shortest distance between the common electrode feeding part 86 and the bypass interconnection 95 longer than the shortest distance between the common electrode feeding part 86 and the individual electrode 88, it is possible to suppress the occurrence of the short circuit due to the ink bridge between the common electrode feeding part 86 and the bypass interconnection 95 to thereby enhance the reliability of driving.

Further, in the present embodiment, when defining the shortest distance between the common electrode feeding part 86 and the bypass interconnection 95 as D1, and the shortest distance between the common electrode 85 and the individual electrode 88 as D3, the relationship of D1≥D3 is provided. According to this configuration, by making the shortest distance between the common electrode feeding part 86 and the bypass interconnection 95 equal to or longer than the shortest distance between the common electrode 85 and the individual electrode 88 (i.e., the thickness of the drive wall 65), a sufficient distance is ensured between the common electrode feeding part 86 and the bypass interconnection 95, and thus, the occurrence of the short circuit due to the ink bridge between the common electrode feeding part 86 and the bypass interconnection 95 can more reliably be suppressed.

Further, in the present embodiment, the common electrode feeding part 86 which is formed along the opening edge of the first opening 61A so as to have an annular shape and is coupled to the common electrode 85, and the partition groove (the decoupling groove) which extends in the X-axis direction to decouple the common electrode feeding part 86 and the individual electrode feeding part 89 from each other are disposed on the first principal surface 53A, and when defining the smallest width of the bypass interconnection 95 as W1, and the smallest width of the individual electrode 88 in the region in which the partition groove 91 is disposed as W2, the relationship of W1>W2 is provided. According to this configuration, since the smallest width of the bypass interconnection 95 is equal to or larger than the smallest width of the individual electrode 88 in the region in which the partition groove 91 is disposed, it is possible to prevent the wiring resistance in the bypass interconnection 95 from becoming higher than the wiring resistance in that region. Thus, it is possible to prevent the broken line of the bypass interconnection 95 due to the electrical load at the time of driving (ejection).

Further, the inkjet head 5 (the liquid jet head) according to the present embodiment is provided with the head chip 50 described above. According to this configuration, the reliability of driving can be enhanced.

Further, the printer 1 (the liquid jet recording apparatus) according to the present embodiment is provided with the inkjet heads 5 described above. According to this configuration, the reliability of driving can be enhanced.

### Second Embodiment

Next, a second embodiment of the present disclosure will be described. In the following description, constituents the same or substantially the same as those of the embodiment described above are denoted by the same reference symbols, and the explanation thereof will be simplified or omitted.

FIGS. 7A to 7C are each a configuration diagram of an essential part of the actuator plate 53 related to the second embodiment.

As shown in FIG. 7C, the ejection channel 61 is provided with the uprise part 61b gradually decreasing in dimension in the Y-axis direction toward the −Z side (the first principal surface 53A side) in the Z-axis direction when viewed from the X-axis direction. As shown in FIG. 7B, the bypass interconnection 95 in the second embodiment is formed so as to cross the uprise part 61b when viewed from the Z-axis direction.

In the second embodiment, the bypass interconnection 95 is disposed so as to cross a formation area of the uprise part 61b. By disposing the bypass interconnection 95 in such a manner, it is possible to suppress growth in size of the actuator plate 53 in the Y-axis direction (in particular toward the +Y side) by adding the bypass interconnection 95. That is, it is possible to make a contribution to a reduction in size of the head chip 50.

### Third Embodiment

Then, a third embodiment of the present disclosure will be described. In the following description, constituents the same or substantially the same as those of the embodiment described above are denoted by the same reference symbols, and the explanation thereof will be simplified or omitted.

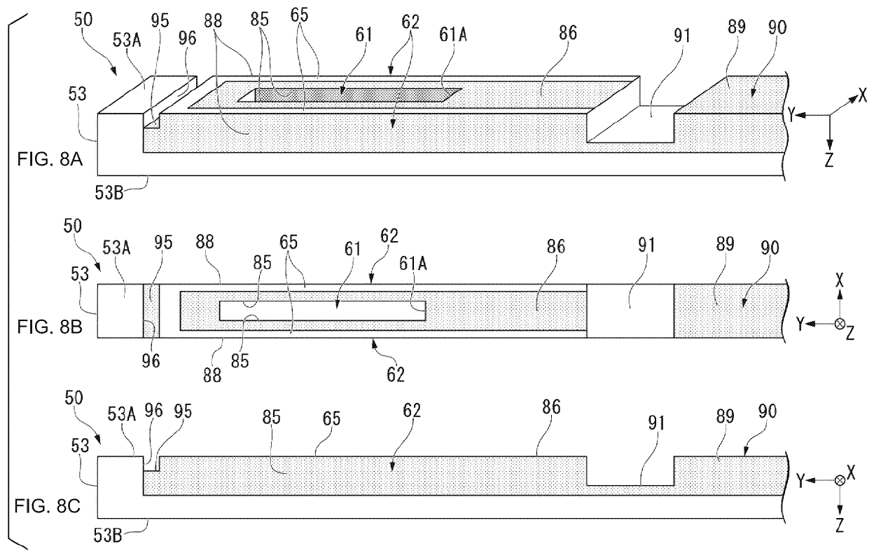

FIGS. 8A to 8C are each a configuration diagram of an essential part of the actuator plate 53 related to the third embodiment.

As shown in FIGS. 8A, 8B, in the third embodiment, a bypass groove 96 linearly extending in the X-axis direction is disposed on the first principal surface 53A at the +Y side of the first opening 61A and the common electrode feeding part 86. Further, the bypass interconnection 95 is formed on a bottom surface of the bypass groove 96. It should be noted that the bypass interconnection 95 may be formed on a side wall surface of the bypass groove 96 as long as the bypass interconnection 95 can couple the pair of individual electrodes 88 located across the ejection channel 61 to each other.

In the third embodiment, the bypass interconnection 95 is formed in the bypass groove 96 which is provided at a constant depth to the first principal surface 53A. By providing the bypass groove 96 in such a manner, the bypass interconnection 95 is not formed coplanar with the common electrode feeding part 86, and thus, the occurrence of the short circuit due to the ink bridge between the common electrode feeding part 86 and the bypass interconnection 95 can reliably be suppressed.

### Fourth Embodiment

Next, a fourth embodiment of the present disclosure will be described. In the following description, constituents the same or substantially the same as those of the embodiment described above are denoted by the same reference symbols, and the explanation thereof will be simplified or omitted.

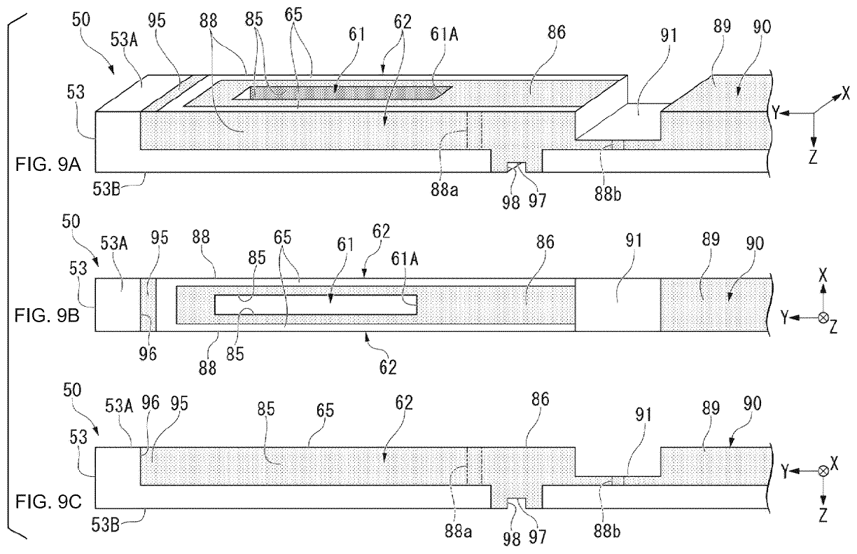

FIGS. 9A to 9C are each a configuration diagram of an essential part of the actuator plate 53 related to the fourth embodiment.

As shown in FIGS. 9A, 9C, in the fourth embodiment, a second bypass groove 98 linearly extending in the X-axis direction is disposed on the second principal surface 53B at the −Y side of a second opening (an upper end opening) opening on the second principal surface 53B and the +Y side of the partition groove 91 in the ejection channel 61. Further, a second bypass interconnection 97 is formed on a bottom surface of the second bypass groove 98. It should be noted that the second bypass interconnection 97 may be formed on a side wall surface of the second bypass groove 98 as long as the second bypass interconnection 97 can couple the pair of individual electrodes 88 located across the ejection channel 61 to each other.

As described above, in the fourth embodiment, the second bypass interconnection 97 which is disposed between the second opening that opens on the second principal surface 53B in the ejection channel 61 and the partition groove 91 in the Y-axis direction, and couples the pair of individual electrodes 88 is disposed on the second principal surface 53B of the actuator plate 53. According to this configuration, the risk of the broken line in a region of the partition groove 91 where the width of the individual electrode 88 decreases can be avoided with the second bypass interconnection 97. For example, in the individual electrode 88, the risk of the broken line is higher in a region denoted by the reference numeral 88b than in a region denoted by the reference numeral 88a, but even when the broken line occurs in the region denoted by the reference numeral 88b, since the pair of individual electrodes 88 are coupled to each other via the second bypass interconnection 97 at a back side (the +Y side) of that region, the reliability of driving can be enhanced even when the broken line supposedly occurs in the bypass interconnection 95. It should be noted that when the broken line occurs in the region denoted by the reference numeral 88a, the second bypass interconnection 97 does not function, but by the bypass interconnection 95 functioning, the pair of individual electrodes 88 can be coupled to each other. Incidentally, when providing the second bypass interconnection 97, deposition of the electrode film on the second principal surface 53B is additionally required.

It should be noted that the scope of the present disclosure is not limited to the embodiments described above, but a variety of modifications can be applied within the scope or the spirit of the present disclosure.

For example, in the embodiment described above, the description is presented citing the inkjet printer as an example of the liquid jet recording apparatus, but the liquid jet recording apparatus is not limited to the printer. For example, a facsimile machine, an on-demand printing machine, and so on can also be adopted.

In the embodiments described above, the description is presented citing the configuration (a so-called shuttle machine) in which the inkjet heads move with respect to the recording target medium when performing printing as an example, but this configuration is not a limitation. The configuration related to the present disclosure can be adopted as the configuration (a so-called stationary head machine) in which the recording target medium is moved with respect to the inkjet heads in the state in which the inkjet heads are fixed.

In the embodiments described above, there is explained when the recording target medium P is paper, but this configuration is not a limitation. The recording target medium P is not limited to paper, but can also be a metal material or a resin material, and can also be food or the like.

In the embodiments described above, there is explained the configuration in which the liquid jet heads are installed in the liquid jet recording apparatus, but this configuration is not a limitation. Specifically, the liquid to be jetted from the liquid jet heads is not limited to what is landed on the recording target medium, but can also be, for example, a medical solution to be blended during a dispensing process, a food additive such as seasoning or a spice to be added to food, or fragrance to be sprayed in the air.

In the embodiments described above, there is explained the configuration in which the Z-axis direction coincides with the gravitational direction, but this configuration is not a limitation, and it is also possible to set the Z-axis direction to a direction along the horizontal direction.

In the embodiments described above, there is explained the configuration (so-called pulling-shoot) of deforming the actuator plate in the direction of increasing the volume of the ejection channel due to the application of the voltage, and then restoring the actuator plate to thereby eject the ink, but this configuration is not a limitation. It is possible for the head chip according to the present disclosure to be provided with a configuration (so-called pushing-shoot) in which the ink is ejected by deforming the actuator plate in a direction of reducing the volume of the ejection channel due to the application of the voltage. When performing the pushing-shoot, the actuator plate deforms so as to bulge toward the inside of the ejection channel due to the application of the drive voltage. Thus, the volume in the ejection channel decreases to increase the pressure in the ejection channel, and thus, the ink located in the ejection channel is ejected outside through the nozzle hole. When setting the drive voltage to zero, the actuator plate is restored. As a result, the volume in the ejection channel is restored.

Besides the above, it is arbitrarily possible to replace the constituents in the embodiments described above with known constituents within the scope or the spirit of the present disclosure, and it is also possible to arbitrarily combine the modified examples described above with each other.

What is claimed is:

1. A head chip comprising:
an actuator plate in which jet channels to be filled with a liquid and non-jet channels not to be filled with the liquid each extend in a first direction, and are alternately formed in a second direction crossing the first direction across drive walls;
a first electrode formed on an inner surface of the jet channel; and
a second electrode formed on an inner surface of the non-jet channel, wherein
a first principal surface facing to one side in a third direction crossing the first direction and the second direction in the actuator plate includes
a second electrode feeding part disposed at one side in the first direction of a first opening which opens on the first principal surface in the jet channel and configured to supply drive power to a pair of second electrodes which are located across the jet channel in the second direction and each of which is identical to the second electrode, and
a bypass interconnection disposed at another side in the first direction of the first opening, and configured to couple the pair of second electrodes to each other.

2. The head chip according to claim 1, wherein
a first electrode feeding part which is formed along an opening edge of the first opening to have an annular shape, and is coupled to the first electrode is provided to the first principal surface, and
when defining a shortest distance between the first electrode feeding part and the bypass interconnection as D1, and a shortest distance between the first electrode feeding part and the second electrode as D2, the following relationship is provided:
D1>D2.

3. The head chip according to claim 1, wherein
a first electrode feeding part which is formed along an opening edge of the first opening to have an annular shape, and is coupled to the first electrode is provided to the first principal surface, and
when defining a shortest distance between the first electrode feeding part and the bypass interconnection as D1, and a shortest distance between the first electrode and the second electrode as D3, the following relationship is provided:
D1≥D3.

4. The head chip according to claim 1, wherein
the first principal surface includes
a first electrode feeding part which is formed along an opening edge of the first opening to have an annular shape, and is coupled to the first electrode, and
a decoupling groove extending in the second direction and configured to decouple the first electrode feeding part and the second electrode feeding part from each other, and
when defining a smallest width of the bypass interconnection as W1, and a smallest width of the second electrode in a region where the decoupling groove is disposed as W2, the following relationship is provided:
W1≥W2.

5. The head chip according to claim 1, wherein
the jet channel includes an uprise part gradually decreasing in dimension in the first direction toward one side in the third direction when viewed from the second direction, and
the bypass interconnection is formed so as to cross the uprise part when viewed from the third direction.

6. The head chip according to claim 1, wherein
the first principal surface includes
a first electrode feeding part which is formed along an opening edge of the first opening to have an annular shape, and is coupled to the first electrode, and
a bypass groove extending in the second direction at another side in the first direction of the first opening, and
the bypass interconnection is formed in the bypass groove.

7. The head chip according to claim 1, wherein
the first principal surface includes
a first electrode feeding part which is formed along an opening edge of the first opening to have an annular shape, and is coupled to the first electrode, and
a decoupling groove extending in the second direction and configured to decouple the first electrode feeding part and the second electrode feeding part from each other, and
a second principal surface facing to another side in the third direction in the actuator plate includes
a second bypass interconnection which is disposed between a second opening that opens on the second principal surface in the jet channel and the decoupling groove in the first direction, and extends in the second direction to couple a pair of second electrodes each identical to the second electrode to each other.

8. A liquid jet head comprising:
the head chip according to claim 1.

9. A liquid jet recording apparatus comprising:
the liquid jet head according to claim 8.
